(19) United States
(12) Patent Application Publication
(10) Pub. No.: US 2016/0057831 A1
(43) Pub. Date: Feb. 25, 2016

(54) SOLID-STATE LIGHT SOURCE MODULE, SOLID-STATE LIGHTING SYSTEM AND OPERATING METHOD THEREOF

(71) Applicant: National Applied Research Laboratories, Hsinchu City (TW)

(72) Inventors: Chun-Ming HUANG, Hsinchu City (TW); Gang-Neng Sung, Hsinchu City (TW)

(21) Appl. No.: 14/520,822

(22) Filed: Oct. 22, 2014

(30) Foreign Application Priority Data
Aug. 20, 2014 (TW) 103128675

(51) Int. Cl. H05B 33/08

(52) U.S. Cl. CPC H05B 33/0845; H05B 33/0896

(57) ABSTRACT

A solid-state light source module that is utilized to be arranged in at least one dimension to form a solid-state lighting system is provided. The solid-state light source module includes a main body, a signal input interface, a signal output interface, a solid-state light source, and a control unit. The signal input interface is utilized to receive at least one location input command. The signal output interface is utilized to issue a location output command. The control unit is utilized to add one to the second location input command to serve as the location output command, and to control luminosity of the solid-state light source. A solid-state lighting system and an operating method thereof are also provided.

### CROSS-REFERENCE TO RELATED APPLICATIONS

This application claims priority from Taiwan Patent Application No. 103128675, filed in the Taiwan Patent Office on Aug. 20, 2014, entitled “SOLID-STATE LIGHT SOURCE MODULE, SOLID-STATE LIGHTING SYSTEM AND OPERATING METHOD THEREOF,” and incorporates the Taiwan patent application in its entirety by reference.

### TECHNICAL FIELD OF THE INVENTION

The present invention relates to solid-state lighting, and in particular to a solid-state light source module, solid-state lighting system, and operating method thereof.

### BACKGROUND OF THE INVENTION

Light-emitting diode (LED) lighting market is increasing year by year, and its goal is to replace the traditional lighting. With the rising of energy conservation issue, the energy-saving LED is thereby rising. The LED is a new application of lighting sources, and it can be developed in the future in several directions, which includes to improve control design of the traditional light sources; to enhance sense of design, e.g. walls, windows, and other urban lighting applications; and to develop intelligent features. In addition, owing to a small size of the LED and a built-in feature, flexibility of appearance design will greatly enhance, and it will overthrow the usage pattern of consumers for the traditional light sources.

Among them, ambience lighting employing a combination of multiple LED lamps with multicolor changes will be a very important aspect in the LED lighting market. Typically, in realizing a conventional 3-dimensional (3D) LED Cube system, it is made up of multiple LEDs and a control circuit board, and every LED is respectively connected to the control circuit board. This way, the production costs and difficulty of the 3D LED cube will greatly enhance. When some LED failures occur, the complexity of repair is further increased. On the other hand, the prior art lighting control system, which includes e.g. digital addressable lighting interface (DALI), digital multiplex (DMX), has certain restrictions on a number of the controllable LED lamps for addressing. For example, the DALI is only capable of controlling 64 light sources or lamps, and it is difficult to arbitrarily increase or reduce the number of the LEDs.

Accordingly, in order to achieve the goal of freely increasing or reducing the LED lamps and controlling their light color, it is necessary to provide a solid-state light source module and solid-state lighting system with an automatic addressing function.

### SUMMARY OF THE INVENTION

an objective of the present invention is to provide a solid-state light source module, which has functions of automated addressing and command parsing by a modularity design.

Another objective of the present invention is to provide a solid-state lighting system, which consists of the plurality of solid-state light source modules. Since each of the solid-state light source modules is an independent modular structure which has the functions of automatic addressing and command parsing, the system allows users to arbitrarily increase or decrease the number of the solid-state light source modules.

Yet another objective of the present invention is to an operating method of the solid-state lighting system. Since each of the solid-state light source modules employed by the method is an independent modular structure which has the functions of automatic addressing and command parsing, the system allows users to arbitrarily increase or decrease the number of the solid-state light source modules.

To achieve the foregoing objectives, according to an aspect of the present invention, the solid-state light source module provided by the present invention is utilized to be arranged in at least one dimension to form a solid-state lighting system. The solid-state light source module includes a main body, at least one signal input interface, at least one signal output interface, at least one solid-state light source, and a control unit. The main body has at least one input side and at least one output side, and the at least one input side corresponds to the at least one output side. The at least one signal input interface is disposed on the at least one input side, and utilized to receive at least one location input command. The at least one signal output interface is disposed on the at least one output side, and utilized to issue at least one location output command. The at least one solid-state light source is disposed within the main body. The control unit is electrically coupled to the at least one signal input interface the at least one signal output interface, and the at least one solid-state light source, and utilized to add one to the at least one location input command to serve as the at least one location output command, and to control luminosity of the at least one solid-state light source.

In one preferred embodiment, the at least one signal input interface is further utilized to receive a dimming command, which comprises a target address information and a luminous intensity information. Specifically, when the target address information is consistent with the at least one location output command, the control unit controls the at least one solid-state light source to radiate according to the luminous intensity information.

In one preferred embodiment, the control unit includes a power interface, a data input interface, a data output interface, and a solid-state light source control interface. The data input interface is coupled to the at least one signal input interface, the data output interface is coupled to the at least one signal output interface, and the solid-state light source control interface is coupled to the at least one solid-state light source. In addition, the power interface is utilized to supply power to the control unit, and the power interface comprises a voltage input pin and a common ground pin.

In one preferred embodiment, the control unit further includes a location determining interface, and the location determining interface is utilized to determine whether the solid-state light source module is arranged at a first position in the at least one dimension. Preferably, the location determining interface, which is coupled to the at least one input side, is utilized to receive voltage, current, magnetic field, pressure, or light wave signals.

In one preferred embodiment, the control unit includes an addressing complete flag, and the addressing complete flag is utilized to verify whether an addressing in one dimension is completed or not.

In one preferred embodiment, the at least one solid-state light source comprises a light-emitting diode, an organic light-emitting diode, or a polymer light-emitting diode.

In one preferred embodiment, the main body is a cube with six faces. The at least one input side is three faces of the six faces, and the at least one output side is the remaining three faces of the six faces. The at least one signal input interface is three signal input interfaces, and the at least one signal output interface is three signal output interfaces.

To achieve the foregoing objectives, the solid-state lighting system provided by the present invention has a plurality of solid-state light source modules arranged in three dimensions. The solid-state lighting system includes a first solid-state light source module and a second solid-state light source module.

The first solid-state light source module is arranged at a first position along a first dimension. The first solid-state light source module includes a first main body, a first signal input interface, a first signal output interface, a first solid-state light source, and a first control unit. The first main body has a first input side and a first output side, and the first input side corresponds to the first output side. The first signal input interface is disposed on the first input side, and utilized to receive an addressing command. The first signal output interface is disposed on the first output side, and utilized to issue a first location output command. The first solid-state light source is disposed within the first main body. The first control unit is electrically coupled to the first signal input interface the first signal output interface, and the first solid-state light source, and utilized to generate the first location output command which a first dimension address is one, and to control luminosity of the first solid-state light source.

The second solid-state light source module is arranged along the first dimension and adjacent to the first solid-state light source module. The second solid-state light source module includes a second main body, a second signal input interface, a second signal output interface, a second solid-state light source, and a second control unit. The second main body has a second input side and a second output side. The second input side corresponds to the second output side, and the second input side is coupled to the first input side. The second signal input interface is disposed on the second input side, and utilized to receive the first location output command to serve as a second location input command. The second signal output interface is disposed on the second output side, and utilized to issue a second location output command. The second solid-state light source is disposed within the second main body. The second control unit is electrically coupled to the second signal input interface, the second signal output interface, and the second solid-state light source, and utilized to add one to the second location input command to serve as the second location output command, and to control luminosity of the second solid-state light source.

In one preferred embodiment, the first location output command is an address of the first solid-state light source module along the first dimension, and the second location output command is an address of the second solid-state light source module along the first dimension.

In one preferred embodiment, the first signal input interface is further utilized to receive a dimming command, which comprises target address information and luminous intensity information. For example, when the target address information is consistent with the address of the first solid-state light source module, the first control unit controls the first solid-state light source to radiate according to the luminous intensity information; or when the target address information is consistent with the address of the second solid-state light source module, the second control unit controls the second solid-state light source to radiate according to the luminous intensity information.

In one preferred embodiment, the first control unit further includes a first location determining interface, and the first location determining interface is utilized to determine whether the first solid-state light source module is arranged at a first position along the first dimension; and the second control unit further includes a second location determining interface, and the second location determining interface is utilized to determine whether the second solid-state light source module is arranged at the first position along the first dimension. Preferably, the first location determining interface, which is coupled to the first input side, and the second location determining interface, which is coupled to the second input side, are utilized to receive voltage, current, magnetic field, pressure, or light wave signals.

To achieve the foregoing objectives, the method for operating the solid-state lighting system provided by the present invention includes the following steps: providing an addressing command to the first signal input interface of the first solid-state light source module, so that an addressing for the solid-state light source module along the first dimension is completed; providing a dimming command to the first solid-state light source module, where the dimming command comprises a target address information and a luminous intensity information; and controlling a solid-state light source of the solid-state light source module located at the target address information to radiate according to the luminous intensity information.

Preferably, in the step of providing the addressing command, the first control unit has a first dimension location determining interface. After the first dimension location determining interface determines the first solid-state light source module to be arranged at the first position along the first dimension, the first control unit generates the first location output command which a first dimension address is one.

The step of providing the dimming command further includes the following steps: (a) sequentially comparing whether or not the first dimension address of the solid-state light source module along the first dimension is identical to a first dimension address of the target address information, if so, then performing step (b); (b) sequentially comparing whether or not a second dimension address of the solid-state light source module along a second dimension is identical to a second dimension address of the target address information, if so, then performing step (c); and (c) sequentially comparing whether or not a third dimension address of the solid-state light source module along a third dimension is identical to a third dimension address of the target address information, if so, then performing the controlling step.

In comparison with the prior art, the solid-state light source modules employed by the present invention are all independent modular structures, whereby the users can freely increase or decrease the number of the solid-state light source cube. In addition, at the beginning of the system starts, the addressing of every solid-state light source module in the solid-state lighting system is automatically carried out, so that the users can set the brightness and color of any solid-state light source module in the solid-state lighting system individually, by issuing the dimming command.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a schematic drawing illustrating a solid-state light source module according to one preferred embodiment of the present invention;

FIG. 2 is a schematic drawing illustrating the module of FIG. 1 from another perspective;

FIG. 3 is a block diagram illustrating a solid-state light source module according to one preferred embodiment of the present invention;

FIG. 4 is a schematic drawing illustrating a solid-state lighting system according to one preferred embodiment of the present invention;

FIG. 5 is a block diagram illustrating a solid-state lighting system according to one preferred embodiment of the present invention;

FIG. 6 is a flow chart illustrating an operating method of a solid-state lighting system according to one preferred embodiment of the present invention;

FIG. 7 is a flow chart illustrating automatic addressing according to a preferred embodiment of the present invention; and

FIG. 8 is a flow chart illustrating command determination according to a preferred embodiment of the present invention.

### DETAILED DESCRIPTION OF THE INVENTION

The present invention will now be described in detail with reference to a few preferred embodiments thereof as illustrated in the accompanying drawings. The same reference numerals refer to the same parts or like parts throughout the various figures.

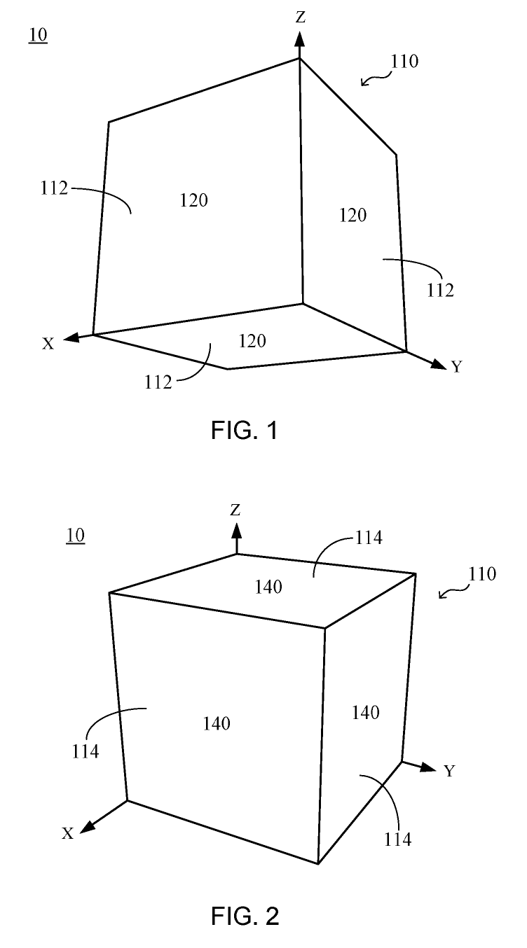

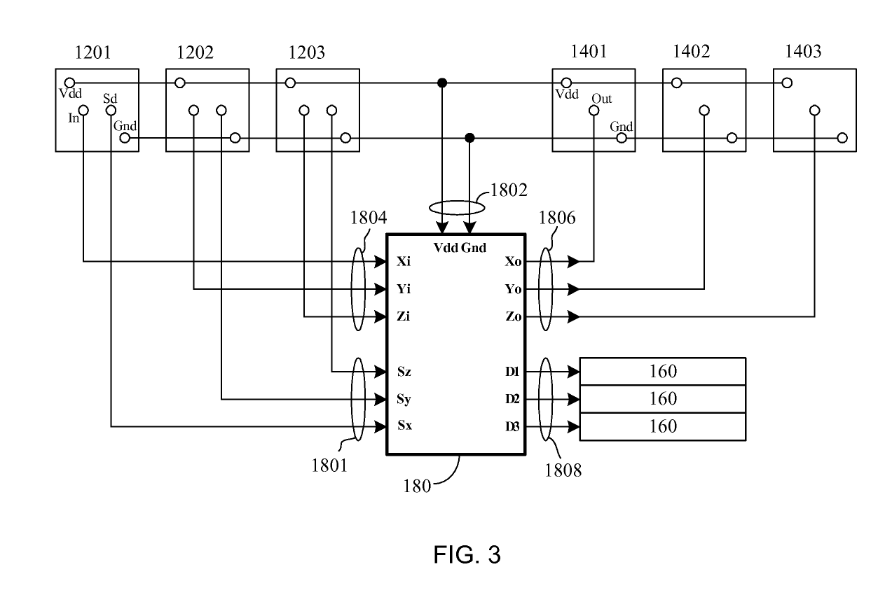

Referring to FIG. 1 to FIG. 3, FIG. 1 is a schematic drawing illustrating a solid-state light source module according to one preferred embodiment of the present invention; FIG. 2 is a schematic drawing illustrating the module of FIG. 1 from another perspective; FIG. 3 is a block diagram illustrating a solid-state light source module according to one preferred embodiment of the present invention. The solid-state light source module 10 of the embodiment is utilized to be arranged in at least one dimension (X, Y, and Z) to form a solid-state lighting system. The solid-state light source module 10 includes a main body 110, at least one signal input interface 120, at least one signal output interface 140, at least one solid-state light source 160, and a control unit 180.

As shown in FIG. 1 to FIG. 2, the main body 110 has at least one input side 112 and at least one output side 114. The at least one input side 112 herein corresponds to the at least one output side 114. The at least one signal input interface 120 is disposed on the at least one input side 112, and utilized to receive at least one location input command (Xi, Yi, and Zi). The at least one signal output interface 140 is disposed on the at least one output side 114, and utilized to issue at least one location output command (Xo, Yo, and Zo). The at least one solid-state light source 160 is disposed within the main body 110. As shown in FIG. 3, the control unit 180 is electrically coupled to the at least one signal input interface 120, the at least one signal output interface 140, and the at least one solid-state light source 160.

Specifically, the main body 110 of the embodiment is a cube with six faces. The at least one input side 112 is three faces of the six faces, and the at least one output side 114 is the remaining three faces of the six faces. The at least one signal input interface 120 is three signal input interfaces, which are a first signal input interface 1201, a second signal input interface 1202, and a third signal input interface 1203, respectively. Similarly, the at least one signal output interface 140 is three signal output interfaces, which are a first signal output interface 1401, a second signal output interface 1402, and a third signal output interface 1403, respectively. It should be noted that it is not limited to be a cube in the present invention. Symmetry polygons with more dimensions are also within the scope of the present invention.

As shown in FIG. 3, the control unit 180 is configured to add one to the at least one location input command (Xi, Yi, and Zi) to serve as the at least one location output command (Xo, Yo, and Zo). That is to say, the module adds one to the address given by the previous solid-state light source module to serve as its address, and then issue that to the next solid-state light source module, thereby accomplishing the addressing of the solid-state light source module 10 itself.

In addition, the control unit 180 is further utilized to control luminosity of the at least one solid-state light source 160. More specifically, the at least one signal input interface 120 is further utilized to receive a dimming command, which includes a target address information and a luminous intensity information. Specifically, when the target address information is consistent with the at least one location output command (Xo, Yo, and Zo), the control unit 180 controls the at least one solid-state light source 160 to radiate according to the luminous intensity information. Preferably, the at least one solid-state light source 160 includes a light-emitting diode, an organic light-emitting diode, or a polymer light-emitting diode. In the embodiment, the at least one solid-state light source 160 has the LED lamps of three colors R, G, B, and the luminous intensity of the R, G, B LED lamps can be individually controlled, thereby mixing to form various colors.

What follows is a detail of the specific structure with respect to the control unit 180. The control unit 180 includes a power interface 1802, a data input interface 1804, a data output interface 1806, and a solid-state light source control interface 1808. The data input interface 1804 is coupled to the at least one signal input interface 120; the data output interface 1806 is coupled to the at least one signal output interface 140; and the solid-state light source control interface 1808 is coupled to the at least one solid-state light source 160. The solid-state light source control interface 1808 includes pins D1, D2, and D3. In addition, the power interface 1802 is utilized to supply power from external to the control unit 180. The power interface 1802 includes a voltage input pin Vdd and a common ground pin Gnd.

Moreover, the control unit 180 further includes a location determining interface 1801 that includes pin Sx, Sy, and Sz. The location determining interface 1801 is utilized to determine whether the solid-state light source module 10 is arranged at a first position in the at least one dimension (X, Y, or Z). Preferably, the location determining interface 1801, which is coupled to the at least one input side 112, is utilized to receive voltage, current, magnetic field, pressure, or light wave signals in the input side 112, so as to determine whether there is another solid-state light source module adjacent thereto or not.

Specifically, each signal input interface 120 has a voltage input terminal Vdd, a common ground terminal Gnd, a signal input terminal In, and a location determining terminal Sd. Each signal output interface 140 has a terminal Vdd, a terminal Gnd, and a signal output terminal Out.

It is worth mentioning that the control unit 180 includes an addressing complete flag (not shown), and the addressing complete flag is utilized to verify whether the addressing in one dimension (X, Y, or Z) is completed or not. For example, the addressing complete flag can be a bit that is utilized to designate a status whether the addressing of the solid-state light source module 10 is complete.

It can be seen from the foregoing that the solid-state light source module 10 of the embodiment has the functions of automatic addressing and command parsing (i.e. receive the dimming command) by the modularity design.

The solid-state lighting system consisting of the above-mentioned solid-state light source modules will be explained in detail in the following sections. The solid-state lighting system of the embodiment has a plurality of solid-state light source modules that are arranged in three dimensions (X, Y, and Z). In order to explain clearly, the embodiment is demonstrated just by two solid-state light source modules arranged in the X direction. Other embodiments in the other directions (Y and Z) and other numbers may be deduced by analogy.

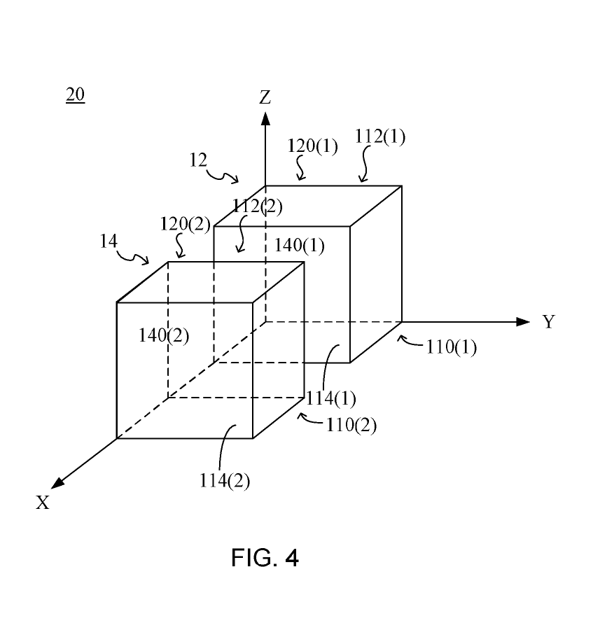

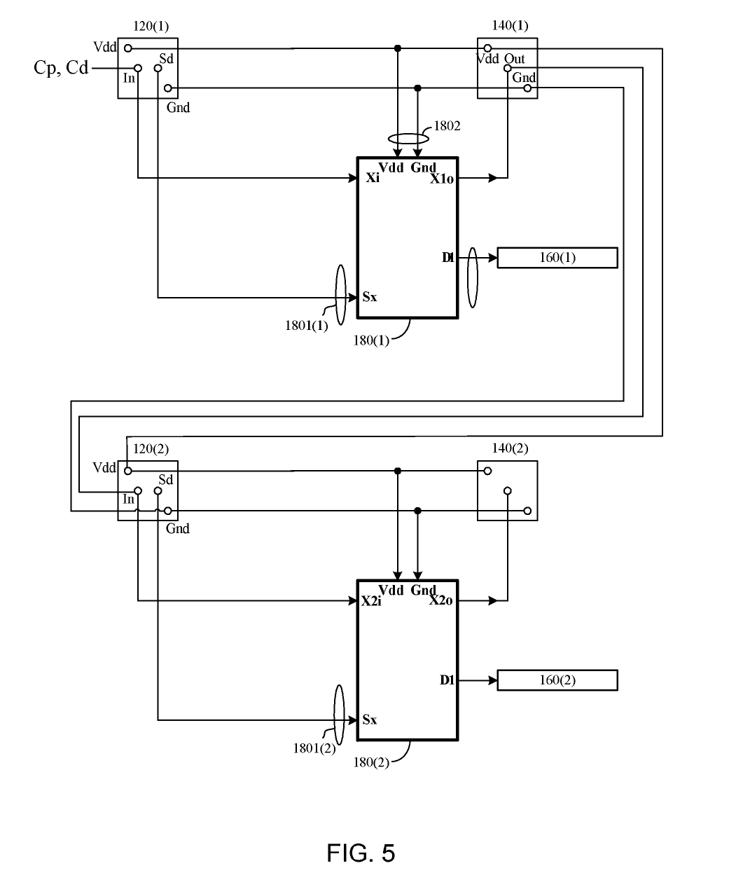

Referring to FIG. 4 and FIG. 5, FIG. 4 is a schematic drawing illustrating a solid-state lighting system according to one preferred embodiment of the present invention; FIG. 5 is a block diagram illustrating a solid-state lighting system according to one preferred embodiment of the present invention. The solid-state lighting system 20 of the embodiment includes a first solid-state light source module 12 and a second solid-state light source module 14. The first solid-state light source module 12 is arranged at a first position along a first dimension X. Similarly, the first solid-state light source module 12 includes a first main body 110(1), a first signal input interface 120(1), a first signal output interface 140(1), a first solid-state light source 160(1), and a first control unit 180(1). It should be noted that, in order to explain clearly, the embodiment is demonstrated just by one first signal input interface 120(1), one first signal output interface 140(1), and one first solid-state light source 160(1) along the first dimension X. The specific description can be referred to the aforementioned.

As shown in FIG. 5, The first signal input interface 120(1) is disposed on the first input side 112(1), and utilized to receive an addressing command Cp. The first signal output interface 140(1) is disposed on the first output side 114(1), and utilized to issue a first location output command Xlo. The first solid-state light source 160(1) is disposed within the first main body 110(1). The first control unit 180(1) is electrically coupled to the first signal input interface 120(1), the first signal output interface 140(1), and the first solid-state light source 160(1), and utilized to generate the first location output command Xlo which a first dimension address is 1, and to control the luminosity of the first solid-state light source 160(1).

As shown in FIG. 4, the second solid-state light source module 14 is arranged along the first dimension X and adjacent to the first solid-state light source module 12. The second solid-state light source module 14 includes a second main body 110(2), a second signal input interface 120(2), a second signal output interface 140(2), a second solid-state light source 160(2), and a second control unit 180(2). The second main body 110(2) has a second input side 112(2) and a second output side 114(2). The second input side 112(2) corresponds to the second output side 114(2), and the second input side 112(2) is coupled to the first output side 114(1). Specifically, the signal output terminal Out of the first signal output interface 140(1) is coupled to the signal input terminal In of the second signal input interface 120(2). The Vdd terminals of both are coupled to each other, and the Gnd terminals of both are coupled to each other.

The second signal input interface 120(2) is disposed on the second input side 112(2), and utilized to receive the first location output command Xlo to serve as a second location input command X2i. The second signal output interface 140(2) is disposed on the second output side 114(2), and utilized to issue a second location output command X2o. The second solid-state light source 160(2) is disposed within the second main body 110(2). The second control unit 180(2) is electrically coupled to the second signal input interface 120(2), the second signal output interface 140(2), and the second solid-state light source 160(2), utilized to add 1 to the second location input command X2i to serve as the second location output command X2o, and to control the luminosity of the second solid-state light source 160(2). Specifically, the first location output command X1o is the address (i.e. 1) of the first solid-state light source module 12 along the first dimension X, and the second location output command X2o is the address (i.e. 2) of the second solid-state light source module 14 along the first dimension X.

Similarly, the first signal input interface is further utilized to receive a dimming command Cd. The dimming command Cd includes target address information and luminous intensity information. For example, when the target address information is consistent with the address (i.e. 1) of the first solid-state light source module 12, the first control unit 180(1) controls the first solid-state light source 160(1) to radiate according to the luminous intensity information. Alternately, when the target address information is consistent with the address (i.e. 2) of the second solid-state light source module 14, the second control unit 180(2) controls the second solid-state light source 160(2) to radiate according to the luminous intensity information.

Similarly, the first control unit 180(1) further includes a first location determining interface 1801(1). The first location determining interface 1801(1) is utilized to determine whether the first solid-state light source module 12 is arranged at the first position along the first dimension X. The second control unit 180(2) further includes a second location determining interface 1801(2). The second location determining interface 1801(2) is utilized to determine whether the second solid-state light source module 14 is arranged at the first position along the first dimension X. In this example, the determination of the first location determining interface 1801(1) is “Yes”, and the determination of the determination the second control unit 180(2) is “No”. Preferably, the first location determining interface 1801(1) is coupled to the first input side 112(1), and the second location determining interface 1801(2) is coupled to the second input side 112(2). Both are utilized to receive the voltage, current, magnetic field, pressure, or light wave signals.

From the above mentioned, by means of the modularity design of each solid-state light source module, the solid-state lighting system 20 has the functions of automatic addressing and command parsing (i.e. receive the dimming command Cd).

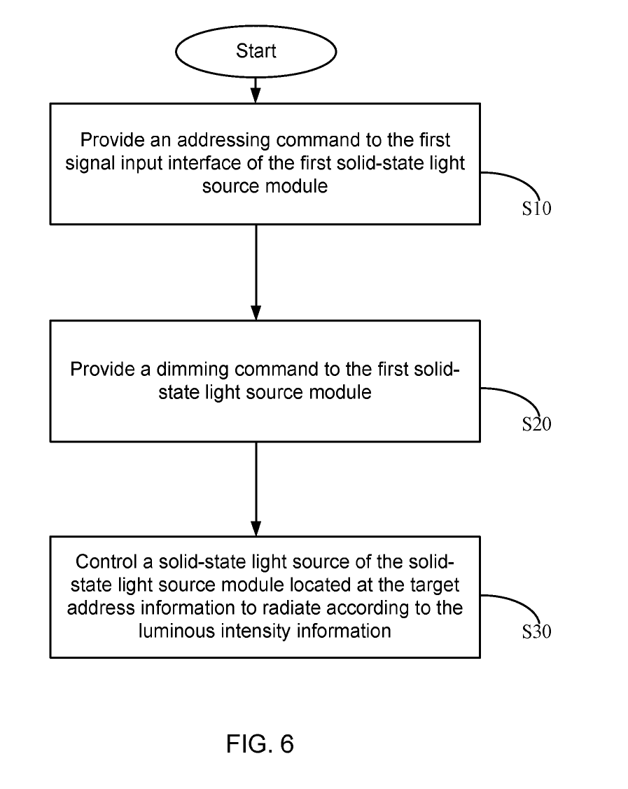

The method for operating the above-mentioned solid-state lighting system will be discussed in detail in the following. Referring to FIG. 3, FIG. 4, and FIG. 6, FIG. 6 is a flow chart illustrating an operating method of a solid-state lighting system according to one preferred embodiment of the present invention. The method begins with step S10.

In step S10, an addressing command Cp is provided to the first signal input interface 120(1) of the first solid-state light source module 12, so that the addressing for the solid-state light source module along the first dimension X is completed, and then execution resumes in step S20.

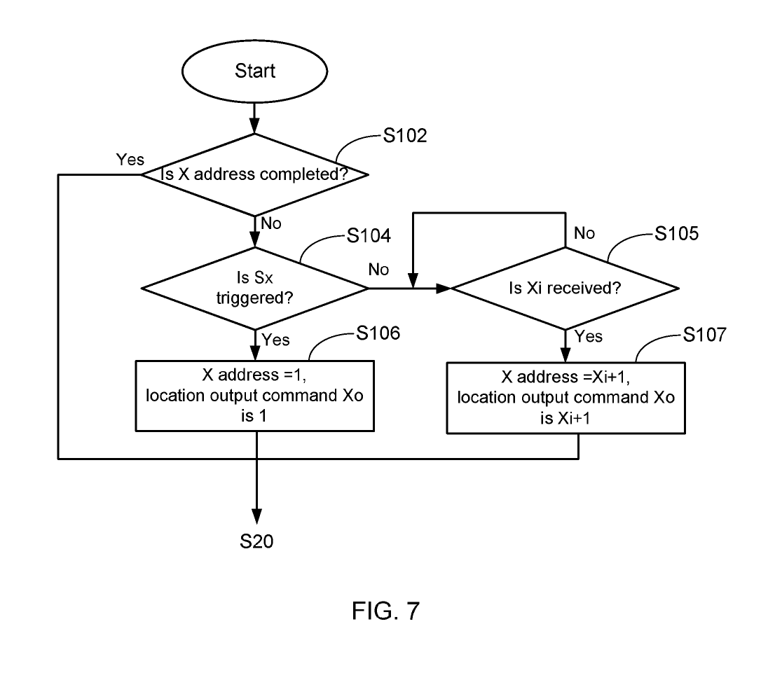

Referring to FIG. 7, FIG. 7 is a flow chart illustrating automatic addressing according to a preferred embodiment of the present invention. The specific steps of the step S10 for automatic addressing begin with step S102.

In step S102, determining whether an X address is completed or not by the addressing complete flag, if yes, then execution resumes in step S20; if not, then execution resumes in step S104.

In step S104, the location determining interface 1801 determines whether the pin Sx is triggered or not. If yes, then execution resumes in step S106; if not, then execution resumes in step S105.

In step S106, that is, the first dimension address is 1, and the location output command Xo is 1, and then performing step S20. Specifically, the first control unit 180(1) has the first dimension location determining interface 1801(1). After the first dimension location determining interface 1801(1) determines the first solid-state light source module 12 to be arranged at the first position along the first dimension X, the first control unit 180(1) generates the first location output command X1o which the first dimension address is 1.

In step S105, determining whether the location input command Xi is received or not, if yes, then execution resumes in step S107; if not, then execution returns to the step S105 to continue determining.

In step S107, that is, the first dimension address is Xi+1, and the location output command Xo is Xi+1, and then performing step S20.

Referring to FIG. 6 again, in step S20, a dimming command is provided to the first solid-state light source module 12, where the dimming command includes a target address information and a luminous intensity information, and then execution resumes in step S30.

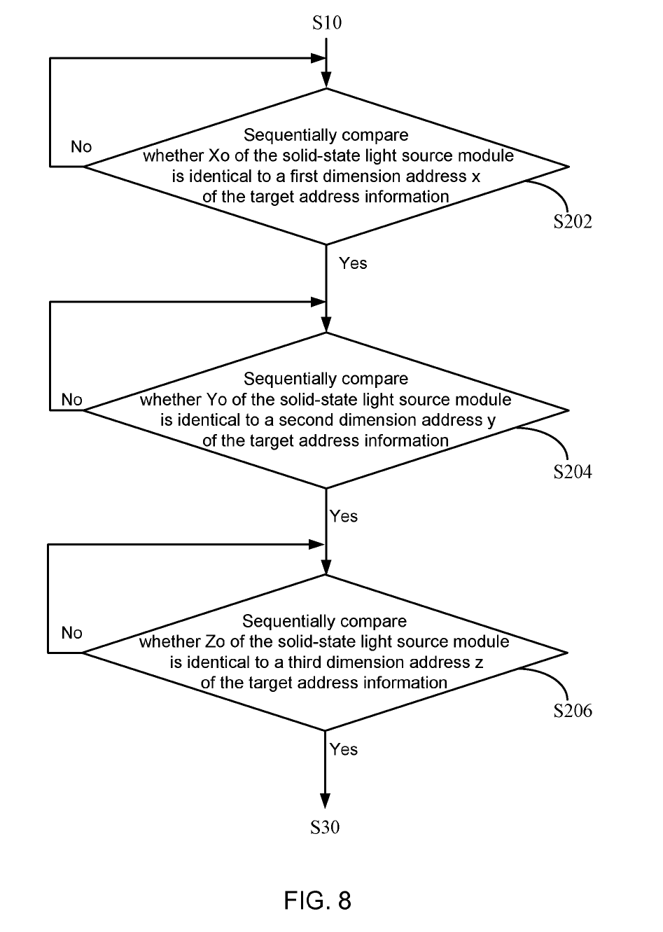

Referring to FIG. 8, FIG. 8 is a flow chart illustrating command determination according to a preferred embodiment of the present invention. The specific steps of the step S20 for the command determination begin with step S202.

In step S202, sequentially comparing whether or not the first dimension address (i.e. Xo) of the solid-state light source module along the first dimension X is identical to a first dimension address x of the target address information, if so, then execution resumes in S204. If not, then execution returns to the step S202 to continue comparing.

In step S204, sequentially comparing whether or not a second dimension address (i.e. Yo) of the solid-state light source module along the second dimension Y is identical to a second dimension address y of the target address information, if so, then execution resumes in S206. If not, then execution returns to the step S204 to continue comparing.

In step S206, sequentially comparing whether or not a third dimension address (i.e. Zo) of the solid-state light source module along the third dimension Z is identical to a third dimension address z of the target address information, if so, then execution resumes in S30. If not, then execution returns to the step S206 to continue comparing.

Referring to FIG. 6 again, in step S30, the solid-state light source 160 of the solid-state light source module that is located at the target address information is controlled to radiate according to the luminous intensity information.

In summary, the solid-state light source modules of the method are all independent modular structures, so that the users can arbitrarily increase or decrease the number of the solid-state light source modules. Moreover, at the beginning of the system starts, the addressing of every solid-state light source module in the solid-state lighting system can be automatically carried out, so that the users can set the brightness and color of any solid-state light source module in the solid-state lighting system individually, by issuing the dimming command Cd.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A solid-state light source module which is utilized to be arranged in at least one dimension to form a solid-state lighting system, the solid-state light source module comprising:
a main body having at least one input side and at least one output side, the at least one input side corresponding to the at least one output side;
at least one signal input interface disposed on the at least one input side, utilized to receive at least one location input command;
at least one signal output interface disposed on the at least one output side, utilized to issue at least one location output command;
at least one solid-state light source disposed within the main body; and
a control unit electrically coupled to the at least one signal input interface, the at least one signal output interface, and the at least one solid-state light source, utilized to add one to the at least one location input command to serve as the at least one location output command, and to control luminosity of the at least one solid-state light source.

2. The solid-state light source module of claim 1, wherein the at least one signal input interface is further utilized to receive a dimming command, which comprises a target address information and a luminous intensity information.

3. The solid-state light source module of claim 2, wherein when the target address information is consistent with the at least one location output command, the control unit controls the at least one solid-state light source to radiate according to the luminous intensity information.

4. The solid-state light source module of claim 1, wherein the control unit comprises a power interface, a data input interface, a data output interface, and a solid-state light source control interface.

5. The solid-state light source module of claim 4, wherein the data input interface is coupled to the at least one signal input interface, the data output interface is coupled to the at least one signal output interface, and the solid-state light source control interface is coupled to the at least one solid-state light source.

6. The solid-state light source module of claim 4, wherein the power interface is utilized to supply power to the control unit, and the power interface comprises a voltage input pin and a common ground pin.

7. The solid-state light source module of claim 1, wherein the control unit further comprises a location determining interface, and the location determining interface is utilized to determine whether the solid-state light source module is arranged at a first position in the at least one dimension.

8. The solid-state light source module of claim 7, wherein the location determining interface, which is coupled to the at least one input side, is utilized to receive voltage, current, magnetic field, pressure, or light wave signals.

9. The solid-state light source module of claim 1, wherein the control unit comprises an addressing complete flag, and the addressing complete flag is utilized to verify whether an addressing in one dimension is completed or not.

10. The solid-state light source module of claim 1, wherein the at least one solid-state light source comprises a light-emitting diode, an organic light-emitting diode, or a polymer light-emitting diode.

11. The solid-state light source module of claim 1, wherein the main body is a cube with six faces, the at least one input side being three faces of the six faces, and the at least one output side being the remaining three faces of the six faces; and wherein the at least one signal input interface is three signal input interfaces, and the at least one signal output interface is three signal output interfaces.

12. A solid-state lighting system having a plurality of solid-state light source modules arranged in three dimensions, the solid-state lighting system comprising:
a first solid-state light source module arranged at a first position along a first dimension, the first solid-state light source module comprising:
a first main body having a first input side and a first output side, the first input side corresponding to the first output side;
a first signal input interface disposed on the first input side, utilized to receive an addressing command;
a first signal output interface disposed on the first output side, utilized to issue a first location output command;
a first solid-state light source disposed within the first main body; and
a first control unit electrically coupled to the first signal input interface, the first signal output interface, and the first solid-state light source, utilized to generate the first location output command which a first dimension address is one, and to control luminosity of the first solid-state light source; and
a second solid-state light source module arranged along the first dimension and adjacent to the first solid-state light source module, the second solid-state light source module comprising:
a second main body having a second input side and a second output side, the second input side corresponding to the second output side, and the second input side coupled to the first input side;
a second signal input interface disposed on the second input side, utilized to receive the first location output command to serve as a second location input command;
a second signal output interface disposed on the second output side, utilized to issue a second location output command;
a second solid-state light source disposed within the second main body; and
a second control unit electrically coupled to the second signal input interface, the second signal output interface, and the second solid-state light source, utilized to add one to the second location input command to serve as the second location output command, and to control luminosity of the second solid-state light source.

13. The solid-state lighting system of claim 12, wherein the first location output command is an address of the first solid-state light source module along the first dimension, and the second location output command is an address of the second solid-state light source module along the first dimension.

14. The solid-state lighting system of claim 12, wherein the first signal input interface is further utilized to receive a dimming command, which comprises a target address information and a luminous intensity information.

15. The solid-state lighting system of claim 14, wherein when the target address information is consistent with the address of the first solid-state light source module, the first control unit controls the first solid-state light source to radiate according to the luminous intensity information; or when the target address information is consistent with the address of the second solid-state light source module, the second control unit controls the second solid-state light source to radiate according to the luminous intensity information.

16. The solid-state lighting system of claim 12, wherein the first control unit further comprises a first location determining interface, and the first location determining interface is utilized to determine whether the first solid-state light source module is arranged at a first position along the first dimension; and the second control unit further comprises a second location determining interface, and the second location determining interface is utilized to determine whether the second solid-state light source module is arranged at the first position along the first dimension.

17. The solid-state lighting system of claim 16, wherein the first location determining interface, which is coupled to the first input side, and the second location determining interface, which is coupled to the second input side, are utilized to receive voltage, current, magnetic field, pressure, or light wave signals.

18. A method for operating the solid-state lighting system of claim 12, comprising the following steps:
providing an addressing command to the first signal input interface of the first solid-state light source module, so that an addressing for the solid-state light source module along the first dimension is completed;
providing a dimming command to the first solid-state light source module, where the dimming command comprises a target address information and a luminous intensity information; and
controlling a solid-state light source of the solid-state light source module located at the target address information to radiate according to the luminous intensity information.

19. The method of claim 18, wherein in the step of providing the addressing command, the first control unit having a first dimension location determining interface, after the first dimension location determining interface determines the first solid-state light source module to be arranged at the first position along the first dimension, the first control unit generates the first location output command which a first dimension address is one.

20. The method of claim 19, wherein the step of providing the dimming command further comprises the following steps:
(a) sequentially comparing whether or not the first dimension address of the solid-state light source module along the first dimension is identical to a first dimension address of the target address information, if so, then performing step (b);
(b) sequentially comparing whether or not a second dimension address of the solid-state light source module along a second dimension is identical to a second dimension address of the target address information, if so, then performing step (c); and
(c) sequentially comparing whether or not a third dimension address of the solid-state light source module along a third dimension is identical to a third dimension address of the target address information, if so, then performing the controlling step.
